(19) United States
(12) Patent Application Publication
(10) Pub. No.: US 2022/0289016 A1
(43) Pub. Date: Sep. 15, 2022

(54) TRACTOR WHEEL DIRECT DRIVE

(71) Applicant: Autonomous Tractor Corporation, St. Michael, MN (US)

(72) Inventor: Terry Anderson, Brookings, SD (US)

(21) Appl. No.: 17/830,766

(22) Filed: Jun. 2, 2022

Related U.S. Application Data
(63) Continuation-in-part of application No. 16/945,487, filed on Jul. 31, 2020.
(60) Provisional application No. 62/881,761, filed on Aug. 1, 2019.

(51) Int. Cl. B60K 7/00; H02K 5/167; H02K 7/00; F16C 17/02

(52) U.S. Cl. CPC B60K 7/0007; H02K 5/167; H02K 7/006; F16C 17/02; B60K 2007/003; B60K 2007/0092; B60T 13/36

(57) ABSTRACT

A wheel assembly for a vehicle comprises a hollow support cylinder extending along an axis and anchored to a frame of the vehicle, and a wheel disposed about the axis, annularly surrounding the hollow support cylinder. The wheel comprises an inner wall and a tire extending radially outward of the inner wall, and anchored thereto. The wheel assembly further comprises first and second sleeve bearings disposed between and abutting the hollow support cylinder and the inner wall, the first sleeve bearing being situated proximal to the frame along the axis, the second sleeve bearing being situated distal to the frame along the axis, and the wheel being rotatably supported on the hollow support cylinder via the first and second sleeve bearings. The wheel assembly further comprises a first direct drive motor disposed axially between the first and second sleeve bearings. The first direct drive motor comprises a first wound stator anchored to the hollow support structure, and a first permanent magnet rotor anchored to the inner wall, axially aligned with the first wound stator and radially outward of the first wound stator.

### CROSS-REFERENCE TO RELATED APPLICATION(S)

This application is a continuation-in-part of U.S. application Ser. No. 16/945,487 filed Jul. 31, 2020 for “Electric Wheel Drive System and Hybrid Vehicle” by T. Anderson and R. Cornelius, which in turn claims the benefit of U.S. Provisional Application No. 62/881,761 filed Aug. 1, 2019 for “Electric Wheel Drive System and Hybrid Vehicle” by T. Anderson and R. Cornelius. The Specification of U.S. application Ser. No. 16/945,487 is herein incorporated by reference.

### BACKGROUND

The present disclosure is related generally to commercial vehicles, and more particularly to direct drive wheel assemblies for commercial vehicles.

There is an increasing need to transition from internal combustion vehicle engines to alternative propulsion systems, due to the rising cost of fossil fuels and the pollutant byproducts from their use. Industries such as transportation and agriculture are particularly susceptible to the ever-rising costs of fossil fuels, as well as the increased cost and reduced availability of new vehicles and replacement parts for existing vehicles. These industries would benefit from alternative propulsive technology in large commercial vehicles, however, such vehicles have higher power demands than standard passenger vehicles and must be constructed robustly enough to meet operational demands, such as moving heavy loads and/or operating off road. It is therefore desirable to design alternatively-powered commercial vehicles with improved life cycles to minimize the financial burden on owners and operators.

### SUMMARY

A wheel assembly for a vehicle comprises a hollow support cylinder extending along an axis and anchored to a frame of the vehicle, and a wheel disposed about the axis, annularly surrounding the hollow support cylinder. The wheel comprises an inner wall and a tire extending radially outward of the inner wall, and anchored thereto. The wheel assembly further comprises first and second sleeve bearings disposed between and abutting the hollow support cylinder and the inner wall, the first sleeve bearing being situated proximal to the frame along the axis, the second sleeve bearing being situated distal to the frame along the axis, and the wheel being rotatably supported on the hollow support cylinder via the first and second sleeve bearings. The wheel assembly further comprises a first direct drive motor disposed axially between the first and second sleeve bearings. The first direct drive motor comprises a first wound stator anchored to the hollow support structure, and a first permanent magnet rotor anchored to the inner wall, axially aligned with the first wound stator and radially outward of the first wound stator.

A vehicle comprises a first wheel assembly comprising a hollow support cylinder extending along an axis and anchored to a frame of the vehicle, and a wheel disposed about the axis, annularly surrounding the hollow support cylinder. The wheel comprises an inner wall and a tire extending radially outward of the inner wall, and anchored thereto. The first wheel assembly further comprises first and second sleeve bearings disposed between and abutting the hollow support cylinder and the inner wall, the first sleeve bearing being situated proximal to the frame along the axis, the second sleeve bearing being situated distal to the frame along the axis, and the wheel being rotatably supported on the hollow support cylinder via the first and second sleeve bearings. The first wheel assembly further comprises a first direct drive motor disposed axially between the first and second sleeve bearings. The first direct drive motor comprises a first wound stator anchored to the hollow support structure, and a first permanent magnet rotor anchored to the inner wall, axially aligned with the first wound stator and radially outward of the first wound stator.

### BRIEF DESCRIPTION OF THE DRAWINGS

FIG. 1 is a schematic cross-sectional view of a direct drive wheel assembly for a vehicle.

FIG. 2 is a schematic illustration of the vehicle with multiple direct drive wheel assemblies.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

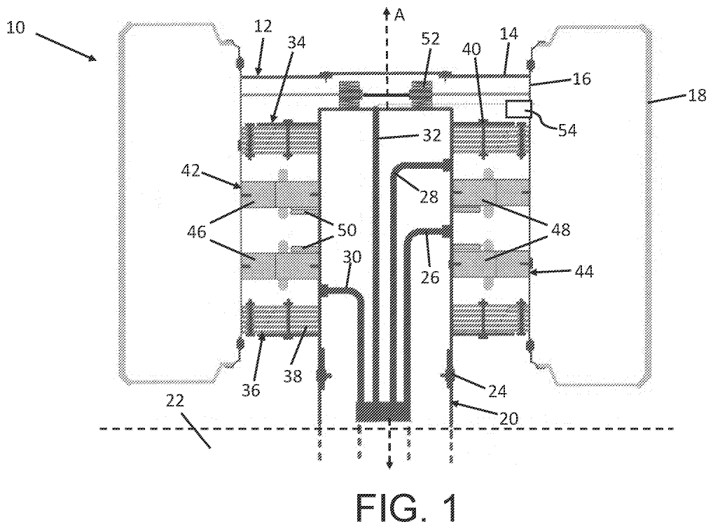

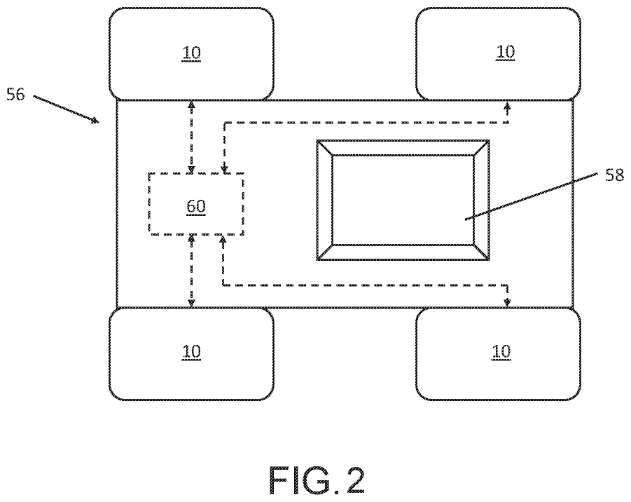

FIG. 1 is a simplified cross-sectional view of wheel assembly 10, according to an exemplary embodiment, in which wheel assembly 10 is a heavy-duty, direct-drive wheel assembly for an agricultural vehicle (e.g., vehicle 56, shown in FIG. 2), such as a tractor. Wheel assembly 10 includes wheel 12 having rim 14 on its periphery and opposing wall portions 16 generally orthogonal to rim 14. Tire 18 can be mounted on rim 14 such that it is a radially outermost structure relative to axis A. Wheel 12 is supported by/mounted on support cylinder 20, which can be formed from steel or other suitable material. Support cylinder 20 connects wheel assembly 10 to frame 22 of vehicle 56, and is longitudinally disposed along axis A. Support cylinder 20 can be removably attached to frame 22 via one or more fasteners 24 to facilitate removal or replacement. Support cylinder 20 is a hollow structure, and serves both as a structural support anchoring wheel assembly 10 to frame 22 of vehicle 56, and as a housing for lines traveling from vehicle 56 to interface with various components of wheel assembly 10. For example, portions of control line 26, lubricant supply line 28, lubricant exhaust line 30, and pressurized air line 32 can all be housed within support cylinder 20. The operation of each line is discussed in greater detail below.

Wheel assembly 10 further includes distal bearing 34 and proximal bearing 36, each in communication with wall portions 16 of wheel 12. As used herein, the terms “distal” and “proximal” refer to a position with respect to frame 22, such that a distal object is axially farther from frame 22 than its proximal counterpart. Bearings 34, 36 can be sleeve bearings disposed to rotatably support tire 18 relative to support cylinder 20. In some embodiments, bearings 34, 36 can also define axial boundaries of an internal space of wheel assembly 10 for lubrication. In the illustrated embodiment, each bearing 34, 36 is formed from multiple plates 38 of steel or other suitable material. Plates 38 can be connected via bolts 40 or other suitable fasteners. This bolted bearing construction facilitates assembly, reduces cost, and simplifies maintenance by enabling partial replacement of faulty sections of bearings 34, 36. In alternative embodiments, however, bearings 34, 36 can be formed monolithically, and/or of other materials.

Distal motor 42 and proximal motor 44 are situated between bearings 34, 36, and can be used to drive tire 18 relative to support cylinder 20. Motors 42, 44 can each be multiphase (e.g., 9-phase) and multipole direct drive motors for driving wheel assembly 10. Each motor 42, 44 includes a radially external rotor 46 anchored to walls 16 of wheel 12, and a radially internal inner stator 48 disposed concentrically within rotor 46 and anchored to support cylinder 20. Rotors 46 can be, for example, permanent magnet rotors. Stators 48 can be, for example, wound stators with external windings formed, in one embodiment, of aluminum. One or more controllers 50 can be attached to stators 48 to control actuation of motors 42, 44. Alternatively, controller(s) 50 can be attached elsewhere within wheel assembly 10. Controller(s) 50 can monitor and/or command electrical devices within wheel assembly 10, and can communicate with vehicle controller 60 (shown in FIG. 2).

Control line 26 can be one or a bundle of lines for supplying electricity from a generator (not shown) or other power source of vehicle 56 to motors 42, 44 and/or for interfacing with controllers 50 and other electrical components (e.g., sensors) of wheel assembly 10. Lubricant supply line 28 supplies lubricating oil to bearings 34, 36 from lubricant source on vehicle 56. In an exemplary embodiment, the source of lubricant can be a generator (not shown) of vehicle 56. Lubricating oil can circulate between and around plates 38 of each bearing. Lubricant exhaust line 30 removes/evacuates used or excess lubricating oil. Pressurized air line 32 carries pressurized air from a source on vehicle 56 (e.g., a compressor) to brake 52, which can be an air-operated disc brake. Pressurized air can also be provided to tire 18, as necessary, and one or more pressure sensors 54 can be included to monitor tire pressure. Accordingly, pressurized air line 32 can include a valving arrangement to distribute air to the various interfacing components. In an exemplary embodiment, the delivery of pressurized air to vary tire pressure can be managed by controller(s) 50.

FIG. 2 schematically illustrates vehicle 56 in plan view. Vehicle 56 can be an agricultural vehicle, such as a tractor or combine. As shown, vehicle 56 includes four wheel assemblies 10, however in an alternative embodiment, vehicle 56 can have fewer than four wheel assemblies 10, such as an embodiment substituting two wheel assemblies 10 for tracks, or substituting two wheel assemblies 10 for conventional (i.e., motorless) wheels. Vehicle 56 can optionally include cab 58 for housing a vehicle operator, as well as vehicle controller 60, which can act as a master controller for wheel assemblies 10. Accordingly, each wheel assembly 10 is in communication with vehicle controller 60.

In operation of vehicle 56, each wheel assembly 10 is independently operable of the other wheel assemblies 10. For a respective wheel assembly 10, motors 42, 44 drive bearings 34, 36 and support cylinder 20 to rotate about a respective axis A to move wheel assembly 10 in a forward or reverse direction. Rotational speed and/or direction of a respective wheel assembly 10 need not match the other wheel assemblies 10, and can be based on communications from controllers 52 or vehicle controller 60. In an exemplary embodiment, vehicle controller 60 can manage the lubricant supply to/from individual wheel assemblies 10. Individual wheel braking, and/or steering can also be independently adjustable for each wheel assembly 10 as desired by the vehicle operator, or more generally as coordinated centrally by vehicle controller 60.

Vehicle 56 need not have a conventional engine for motive force, rather, each wheel assembly 10 is capable of producing sufficient horsepower (e.g., 150-200 HP per motor) to operate vehicle 56. The wheel assemblies described herein are suitable for use in large commercial vehicles, recreational vehicles, and traditional passenger vehicles, to name a few non-limiting examples.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A wheel assembly for a vehicle, the wheel assembly comprising:
a hollow support cylinder extending along an axis and anchored to a frame of the vehicle;
a wheel disposed about the axis, annularly surrounding the hollow support cylinder,
the wheel comprising:
an inner wall; and
a tire extending radially outward of the inner wall, and anchored thereto;
first and second sleeve bearings disposed between and abutting the hollow support cylinder and the inner wall, wherein the first sleeve bearing is situated proximal to the frame along the axis, the second sleeve bearing is situated distal to the frame along the axis, and the wheel is rotatably supported on the hollow support cylinder via the first and second sleeve bearings; and
a first direct drive motor disposed axially between the first and second sleeve bearings, the first direct drive motor comprising:
a first wound stator anchored to the hollow support structure; and
a first permanent magnet rotor anchored to the inner wall, axially aligned with the first wound stator and radially outward of the first wound stator.

2. The wheel assembly of claim 1 and further comprising:
a second direct drive motor disposed axially between the first and second sleeve bearings, the second direct drive motor comprising:
a second wound stator anchored to the hollow support structure; and
a second permanent magnet rotor anchored to the inner wall, axially aligned with the second wound stator and radially outward of the second wound stator.

3. The wheel assembly of claim 2, wherein the first and second direct drive motors are multiphase and multipole motors.

4. The wheel assembly of claim 2, wherein the first stator and the second stator are externally wound with aluminum windings.

5. The wheel assembly of claim 1 and further comprising: a lubricant supply line and a lubricant exhaust line positioned within the hollow support cylinder.

6. The wheel assembly of claim 1 and further comprising:
a pressurized air line positioned within the hollow support cylinder; and
an air-operated disc brake in communication with the pressurized air line.

7. The wheel assembly of claim 1 and further comprising: a pressure sensor for monitoring a pressure of the tire.

8. The wheel assembly of claim 1, wherein each of the first and second sleeve bearings comprises a plurality of plates.

9. The wheel assembly of claim 1 and further comprising: a controller attached to the first direct drive motor.

10. The wheel assembly of claim 1, wherein at least one of the hollow support cylinder, the first sleeve bearing, and the second sleeve bearing are formed from steel.

11. A vehicle comprising:
a first wheel assembly comprising:
a hollow support cylinder extending along an axis and anchored to a frame of the vehicle;
a wheel disposed about the axis, annularly surrounding the hollow support cylinder, the wheel comprising:
an inner wall; and
a tire extending radially outward of the inner wall, and anchored thereto;
first and second sleeve bearings disposed between and abutting the hollow support cylinder and the inner wall, wherein the first sleeve bearing is situated proximal to the frame along the axis, the second sleeve bearing is situated distal to the frame along the axis, and the wheel is rotatably supported on the hollow support cylinder via the first and second sleeve bearings; and
a first direct drive motor disposed axially between the first and second sleeve bearings, the first direct drive motor comprising:
a first wound stator anchored to the hollow support structure; and
a first permanent magnet rotor anchored to the inner wall, axially aligned with the first wound stator and radially outward of the first wound stator.

12. The vehicle of claim 11, wherein the first wheel assembly further comprises:
a second direct drive motor disposed axially between the first and second sleeve bearings, the second direct drive motor comprising:
a second wound stator anchored to the hollow support structure; and
a second permanent magnet rotor anchored to the inner wall, axially aligned with the second wound stator and radially outward of the second wound stator.

13. The vehicle of claim 12 and further comprising:
a second wheel assembly comprising:
a hollow support cylinder extending along an axis and anchored to a frame of the vehicle;
a wheel disposed about the axis, annularly surrounding the hollow support cylinder, the wheel comprising:
an inner wall; and
a tire extending radially outward of the inner wall, and anchored thereto;
first and second sleeve bearings disposed between and abutting the hollow support cylinder and the inner wall, wherein the first sleeve bearing is situated proximal to the frame along the axis, the second sleeve bearing is situated distal to the frame along the axis, and the wheel is rotatably supported on the hollow support cylinder via the first and second sleeve bearings; and
a first direct drive motor disposed axially between the first and second sleeve bearings, the first direct drive motor comprising:
a first wound stator anchored to the hollow support structure; and
a first permanent magnet rotor anchored to the inner wall, axially aligned with the first wound stator and radially outward of the first wound stator.

14. The vehicle of claim 13, wherein the second wheel assembly further comprises:
a second direct drive motor disposed axially between the first and second sleeve bearings, the second direct drive motor comprising:
a second wound stator anchored to the hollow support structure; and
a second permanent magnet rotor anchored to the inner wall, axially aligned with the second wound stator and radially outward of the second wound stator.

15. The vehicle of claim 14, wherein each of the first and second wheel assemblies comprises: a controller attached to the respective first direct drive motors.

16. The vehicle of claim 15 and further comprising: a vehicle controller in communication with the controller of each of the first and second wheel assemblies.

17. The vehicle of claim 14, wherein the first and second direct drive motors of each of the wheel assemblies are multiphase and multipole motors.

18. The vehicle of claim 14, wherein each of the first and second wheel assemblies further comprises:
a lubricant supply line positioned within the hollow support cylinder;
a lubricant exhaust line positioned within the hollow support cylinder;
a pressurized air line positioned within the hollow support cylinder;
an air-operated disc brake in communication with the pressurized air line; and
a pressure sensor for monitoring a pressure of the tire.

19. The vehicle of claim 14, wherein for each of the first and second wheel assemblies, each of the first and second sleeve bearings comprises a plurality of plates.

20. The vehicle of claim 14, wherein for each of the first and second wheel assemblies, at least one of the hollow support cylinder, the first sleeve bearing, and the second sleeve bearing are formed from steel.
